(19) United States
(12) Patent Application Publication
(10) Pub. No.: US 2004/0009724 A1
(43) Pub. Date: Jan. 15, 2004

(54) Method for identifying origin of and detecting defects in glass and quartz fiber products

(76) Inventors: H. Landis Carter, Greer, SC (US); Shobha Murari, Greenville, SC (US)

Correspondence Address: MCNAIR LAW FIRM, P.O. BOX 10827, GREENVILLE, SC, 29603-0827, US

(21) Appl. No.: 10/373,462

(22) Filed: Feb. 24, 2003

Related U.S. Application Data
(60) Provisional application No. 60/360,656, filed on Mar. 1, 2002.
(60) Provisional application No. 60/411,231, filed on Sep. 17, 2002.

(51) Int. Cl. B32B 13/06

(52) U.S. Cl. 442/17; 442/181

(57) ABSTRACT

A method and product for identifying the origin of products having fiberglass components or constituents wherein the glass fibers are coated with a fluorescent agent that glows when subsequently subjected to UV or appropriate wavelength light. Thus by selecting a unique color or pattern a manufacturer can readily identify his products.

### CROSS REFERENCE TO RELATED APPLICATIONS

This application has the same inventors and relates to the same subject matter as disclosed in provisional applications, Serial No. 60/360,656; filed Mar. 1, 2002 and Serial No. 60/411,231; filed Sept. 17, 2002 and both of which are entitled “Fluorescent and Phosphorescent Glass and Quartz Fibers and Fabrics and Method of Making Same.” Priority is claimed from both of said provisional applications.

### FIELD OF THE INVENTION

This invention relates to the chemical attachment of fluorescent and phosphorescent compounds to glass fibers and fabrics and to quartz fibers and fabrics. Particularly, the invention relates to making glass or quartz yarn fabric that has fluorescent or phosphorescent properties. More particularly, the present invention relates to optical identifiers for products incorporating a glass or a quartz fiber or fabric components as part of the product.

### BACKGROUND OF THE INVENTION

The phenomenon of fluorescence may be described as the unique property of a substance to absorb light of varying frequencies, and possess the ability to re-emit this energy as light of a longer wavelength causing the material to produce a brilliant “glow” of light. A fluorescent body can accomplish this because it has the capacity to convert short wavelength (High Energy) photons of light into a predominantly longer and more intense wavelength of energy. This is in contrast to a conventional colorant, which can only reflect the small portion of light from the visible spectrum that provides its unique color.

For example, a conventional colorant such as orange can absorb white light and reflect only the orange band (approx. 600 nm) of the visible spectrum. The rest of the spectrum (red, yellow, green, blue, indigo, and violet) will be dissipated as heat. A fluorescent orange color however, absorbs white light and converts the lower wavelength colors (yellow, green, blue, indigo, violet) along with longer UV energy into a single, more intense band of light as opposed to losing these wavelengths as heat. This conversion of ultraviolet and visible radiation is therefore, the origin for the name daylight fluorescent pigments.

Generally, fluorescent additives or pigments can be any pigment or additive that absorbs light at certain frequencies and re-emits light at lower frequencies thus making articles containing these pigments appear to possess an actual glow of their own. The type known as daylight fluorescent pigments (Day-Glo pigments) respond to radiation in both the ultraviolet and visible ranges causing the effect of glowing in normal daylight. These pigments are comprised of fluorescent dyes incorporated in a clear-resin matrix, ground to powder form. Urea and melamine resins have been used as matrices, and also used have been modified sulfonamide resins. Other prior art of interest can be found in U.S. Pat. No. 4,900,614, U.S. Pat. No. 4,291,095, U.S. Pat. No. 3,427,273, U.S. Pat. No. 4,442,170, U.S. Pat. No. 5,583,195, and U.S. Pat. No. 5,194,289. Pigments and additives can be obtained from such manufacturers as AlliedSignal and Orco.

Another class of light emitting additives or pigments includes the phosphorescent pigments which are a family of pigments, generally inorganic sulfide crystals of fairly large and controlled size, that absorb the energy of incident light then slowly re-emit it as radiation of a color specific to each pigment. The phosphorescence gradually dims in darkness, to be renewed by the next light restimulation.

Both fluorescent and phosphorescent materials are commercially available as either pigments, dyes, or additives. A variety of colors are available, particularly, in the fluorescent materials.

Also, well known in the art are glass and quartz fibers, yarns and fabrics. However, in the art there has heretofore been no satisfactory method of identifying splices in fiberglass yarns, particularly, as the yarns are woven in fabric. Accordingly, it is one object of the present invention to provide a method for detecting splices in fiberglass or quartz yarns.

Furthermore, glass and quartz fabrics have been used in the prior art as reenforcing materials and substrates in many electronic application because of their dielectric properties. One particular use is in the re-enforcement of circuit boards. However, when there is a defect in the reinforcing material it is presently difficult, if not impossible, to identify the manufacturer of the fiberglass if several different suppliers have been used. Thus, another object of the present invention is to provide a method of identifying the manufacturer of glass fabric and products reinforced by glass and quartz fabrics.

Fluorescence has been employed in the prior art for detecting defects in printed circuit boards as disclosed in U.S. Pat. No. 5,266,385 which was granted on Nov. 30, 1993 to Kenji Ishii. In the Kenji patent, the printed circuit employs a fluorescence applied circuit pattern to control circuit quality. However, in the present invention the object is to use a fluorescence glass fiber reinforcing fabric as a means of identifying the origin of a circuit board in order to fix responsibility for a defective board.

It is also known in the art to manufacture surfboards using fiberglass fabric as a surface material. In the past, in low light it is difficult to determine the location of a surfboard when a surfer is separated from the board and the board is floating loose in the surf. Accordingly, it is still another object of the present invention to provide a surfboard which can be readily seen in low light conditions.

The foregoing and other objects are achieved by the present invention which will be better understood by reference to the summary of invention and description that follows.

### SUMMARY OF THE INVENTION

In one aspect, the invention is a novel glass or quartz fiber yarn or fabric that is fluorescent or phosphorescent. The fabric or yarn may also include a combination of fluorescing or phosphoresing additives.

In another aspect, the present invention is a method of incorporating fluorescent or phosphorescent additives into a polymeric coating which will couple to and bond to glass fibers and fabrics or to quartz fibers and fabrics and be coated onto the fabric or fibers manually, by brushing, by rollers, by extrusion coating, or by dipping in a bath. The coating process produces a novel and useful glass fabric, which will fluoresce or phosphoresce and will provide identification of splices, defects, source of materials, and, consequently, the ready identification of origin and retrieval of products.

In still another aspect, the invention is a method of identifying splices in yarn produced in a spinning operation where the yarns are spliced manually and the operator can manually apply a small amount of the polymeric resin containing a fluorescent additive to the splice. Subsequently, when the yarn has been woven into a fabric the splice can be readily identified when passed under a light source that emits light of the frequency which excites the fluorescent additive.

In yet another aspect, an identifying fluorescent color can be added to the coating bath of a fabric so that a unique color identified with the fabric produced by a particular manufacturer will be coated onto the fabric. This can be the manufacturer's “marker.” When the fabric is used as reinforcing mesh in an epoxy resin circuit board, or in other applications, the unique color can be identified when the fabric is passed under a light source of the exciting wavelength. As an alternative, instead of coating the entire fabric with the fluorescent containing polymer, selected warp or fill yarns can be coated with the fluorescent polymer and placed in a pattern on the looms so that a fluorescing strand appears at spaced apart intervals to identify the fabric. The identification of the origin of the components of a high value, finished products can be of utmost importance when determining who made the component of the product that caused the product to fail, to perform improperly, or to meet environmental or safety requirements.

In still another aspect of the present invention, fluorescing or phosphorescing treatments or additives can be coated on to a coating for the glass fiber fabrics used as the reinforcement for a surfboard. For surfers who are out in low light such as late evening and who fall from or lose contact with their surfboards, the fluorescing or phosphorescing board will make the surf board easy to find or to avoid. This is not only a convenience but is also a safety measure so that the location of the board can be quickly ascertained.

In yet another aspect, the present invention is the surprising discovery that certain polymers, preferably vinyl chloride co-polymers, can not only be made to couple and bond to glass fibers but also will act as a carrier for fluorescing or phosphorescing additives. It has also been discovered that certain other polymers can perform in this manner and among these are the acrylic/vinyl chloride/SBR polymers and co-polymers.

As an additional aspect, the present invention is a method of imparting fluorescence in glass and quartz yarns and fabric for identification of origin and detection of defects comprising the steps of preparing a composition comprising a coupling agent and a fluorescing agent, said fluorescing agent being selected from the group consisting of: fluorescing and phosphorescing compounds and pigments, applying said composition to the surface of an article to treat same, said article being selected from the group consisting of: glass fiber, yarn and fabric and quartz fiber, yarn, and fabric; incorporating said treated article into a component of a finished product; and, subsequently irradiating said treated article with light of an exciting wavelength to identify or locate same.

The foregoing invention will be even better understood by reference to the detailed description, which follows:

### DETAILED DESCRIPTION

Since the 1950's, intensive research has yielded many fluorescent compounds, however, only a small number of these compounds have found practical uses. Collectively, these compounds belong to the aromatic or heterocyclic series and may have condensed ring systems. An important feature of these compounds is the presence of an interrupted chain of conjugated double bonds, the number of which is dependent on substituents as well as the planarity of the fluorescent part of the molecule. Almost all of these compounds are derivatives of stilbene or 4,4′-diamonstilbene, biphenyl, 5-membered heterocycles as triazoles, oxazoles, imidazoles, etc., or 6-membered heterocycles (coumarins, naphthylamines, s-triazine.) A feature of the present invention is the surprising discovery of a technique for attaching fluorescent compounds such as the foregoing to glass fibers and fabrics.

The preferred process begins with providing a fiberglass fabric woven in what is known in the textile art as a scrim weave. Previously applied agents or finishing materials need not be removed. The next step is providing a vinyl chloride co-polymer. Vinyl chloride co-polymers are especially useful because of their resistance to deterioration from ultra-violet (UV) light.

### DEFINITIONS

As used herein the following terms are understood to have meanings as set forth:

“Polymer” is understood to include homopolymers, co-polymers, terpolymers, block, graft, and addition polymers.

“Fluorescence” and “fluorescent pigments”, “compounds” or “additives” generally means any pigment or compound or agent that absorbs light at certain frequencies and re-emits it at lower frequencies so that an article containing the pigment or agent appears to glow when exposed to light of the lower frequencies. “Phosphorescent pigments” or “agents” are those which generally absorb the energy of incident light and then slowly re-emit the energy as visible light at the color specific to the pigment or agent.

“Fluorescent” will be used more frequently herein but is understood to include “phosphorescent” agents as well.

“Exciting wavelength” is understood to be light that includes a wavelength or wavelengths that cause the fluorescent agent being irradiated to glow.

“Vinyl chloride polymers” may include polyvinyl chloride, or “PVC”, which includes co-polymers that contain at least 50% vinyl chloride. The co-polymer also may be co-polymerized with vinyl acetate, be compounded with acrylic polymeric processing aids, or co-polymerized with any compatible polymers. But, the particular vinyl chloride co-polymers are those which readily coat onto and couple with and bond to glass fibers and which also can incorporate the above-mentioned fluorescing compounds. The preferred vinyl chloride co-polymer may be applied in any of a number of ways including dipping, rolling, spraying, or extrusion coating and may be applied to the yarn or fabric without the necessity of removing any processing agents previously applied, i.e., the fabric may be used as it comes from the producer and the fabric may be either woven or non-woven. In certain applications for preparing glass fibers the use of an Orco® dispersant such as Synthrowite EMV-132 with a silane coupling agent having a pH in the range of 3-5 can provide a distinct color under UV light.

### EXAMPLE I

In one preferred embodiment, this invention is employed to identify glass fiber mesh that is used as reinforcement in structural and decorative concrete components. Glass fiber mesh with polyvinyl chloride coating for concrete reinforcement is disclosed in patents such as U.S. Pat. No. 4,298,413 granted Nov. 3, 1981 to John W. Teare and U.S. Pat. No. 6,230,465 granted May 15, 2001 to Harold G. Messenger, et al., the disclosures in which are incorporated herein by reference. A unique colored fluorescent pigment is incorporated in the PVC prior to its being coated onto the glass fiber mesh. After the mesh has been used to reinforce concrete a small strand of the mesh will allow the manufacturer of the mesh to be identified. The glass fiber reinforcing mesh also may be incorporated in either Portland cement based concrete because of its alkali resistance or with polymeric concrete compositions.

### EXAMPLE II

A fiber glass scrim woven mesh of 3.8 to 4.8 oz/sq.yd. was passed through a coating bath which included polyvinyl chloride where it picked up 9 to 19 oz/yd. of coating. The bath contained imidazoles from Bayer so that 0.02 to 10% by weight of the coating was the fluorescent constituent. The result was a coating that allows the source of the fabric to be identified by its fluorescent marker under ultraviolet light.

After having read the above disclosure, many other uses of the invention may become apparent to those skilled in the ordinary art but the present invention is limited in scope only to the claims which follow:

We claim:

1. A method of imparting fluorescence in glass and quartz yarns and fabric for identification of origin and detection of defects comprising the steps of:
a) preparing a composition comprising a coupling agent and a fluorescing agent, said fluorescing agent being selected from the group consisting of: fluorescing and phosphorescing compounds and pigments;
b) applying said composition to the surface of an article to treat same, said article being selected from the group consisting of: glass fiber, yarn and fabric and quartz fiber, yarn, and fabric;
c) incorporating said treated article into a component of a finished product; and, subsequently
d) irradiating said treated article with light of an exciting wavelength to identify or locate same.

2. The method of claim 1 wherein the coupling agent is a vinyl chloride polymer.

3. The method of claim 1 wherein the article to be treated is a woven fabric and wherein the composition is applied by dipping the fabric in a bath of the composition.

4. The method of claim 1 wherein the fabric is used as the reinforcing mesh for a circuit board.

5. The article of claim 3 wherein the fabric is used as a reinforcing mesh in concrete.

6. The method of claim 1 wherein the article to be treated is fiberglass incorporated in a surfboard.

7. The method of claim 1 wherein the article to be treated is one end of a fiberglass yarn stand, and including the step of applying said composition to the end or tip of said strand.

8. A method of imparting fluorescence to a glass fabric comprising the steps of:
a) incorporating a fluorescent or phosphorescent additive into a polymeric coating, and
b) applying same to a glass or quartz fabric or yarn to produce a fluorescing fiberglass or quartz yarn.

9. As an article of manufacture, a fluorescent glass fiber product.

10. The article of claim 9 wherein the product is a yarn segment.

11. The article of claim 9 wherein the product is a glass woven fabric.

12. As an article of manufacture, a fluorescent quartz fiber yarn.

13. The article of claim 12 wherein the product is a yarn.

14. The article of claim 12 wherein the product is a woven fabric.

15. In a glass fiber mesh for reinforcing portland cement concrete or for polymeric concrete, wherein the mesh is coated with a polymeric resin, the improvement comprising including a fluorescent material within said coating whereby said mesh can be identified under exciting wavelength source of light.

16. The glass mesh of claim 15 wherein the coating is a vinyl chloride polymer and the fluorescent material is imidazole.

17. In a glass fiber mesh for reinforcing an epoxy circuit board, the improvement comprising the step of applying a fluorescent agent to the fiber of said fabric.

18. The method of claim 17 including applying said fluorescent agent with a vinyl chloride polymer coupling agent.
